(19) United States
(12) Patent Application Publication
(10) Pub. No.: US 2018/0043671 A1
(43) Pub. Date: Feb. 15, 2018

(54) Method Of Applying Hydro-Graphic Film To Articles

(71) Applicant: Closure Systems International Inc., Lake Forest, IL (US)

(72) Inventors: Jeremiah Migas, Crawfordsville, IN (US); Jeremy Morin, Zionsville, IN (US)

(21) Appl. No.: 15/558,127

(22) PCT Filed: Mar. 11, 2016
(86) PCT No.: PCT/US16/21940

§ 371 Date: Sep. 13, 2017

Related U.S. Application Data
(60) Provisional application No. 62/133,020, filed on Mar. 13, 2015.

(51) Int. Cl. B32B 37/00; B41M 3/12; B32B 38/00; B05D 1/18; B05D 3/00

(52) U.S. Cl. CPC B32B 37/025; B05D 1/18; B05D 3/007; B32B 38/145; B41M 3/12; B32B 2439/70

(57) ABSTRACT

The present invention relates to articles such as plastic closures molded from polymeric materials the like having a hydro-graphic film applied thereto for enhancing aesthetic appeal. The present invention further relates to techniques for applying a coating to articles, such as plastic closures, with a hydro-graphic film ink, which method contemplates application of the ink to the articles in a water bath without first drying the ink, thereby maintaining the ink in fluid state, desirably avoiding the time-consuming and sometimes problematic steps of drying and reactivating the hydro-graphic film ink.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### TECHNICAL FIELD

The present invention relates generally to articles such as plastic closures molded from polymeric materials which are used with associated containers for packaging beverages, food products and the like, and more particularly to a molded plastic articles such as closures having a patterned hydro-graphic film applied thereto for enhancing aesthetic appeal. The present invention further relates to techniques for applying a coating to articles, such as plastic closures, and more particularly to a method of coating articles with a hydro-graphic film ink, which method contemplates application of the ink to the articles in a water bath without first drying the ink, thereby maintaining the ink in fluid state, desirably avoiding the time-consuming and sometimes problematic steps of drying and reactivating the hydro-graphic film ink.

### BACKGROUND OF THE INVENTION

Plastic closures molded from polymeric materials, including polypropylene, polyethylene, copolymer blends, and other olefin polymers, have been very commercially successful for use with associated containers for packaging carbonated and non-carbonated beverages, food products, non-food products and the like. Closures of this nature, which can be suitably formed by compression or injection molding, typically include an internal thread formation for threaded engagement with an external thread formation of an associated container. Such closures can be desirably configured to provide effective and reliable tamper-evidence for consumers.

In order to enhance aesthetic appeal of molded plastic closures of this type, pigmentation or other coloration can be incorporated in the polymer composition from which the closures are formed. Heretofore, the overall appears of such closures is typically determined by the composition of the molded polymer, and any pigmentation or coloration of the polymeric material. To a limited extent, graphics can be applied to molded closures, such a by ink-transfer or ink-jet printing, but such printing is ordinarily limited to providing lettering or simple graphics on the closures.

More recently, advances have been made in the technology of hydro-graphic printing, by which printed hydro-graphic film ink is applied to the surface of an article, such a molded closure. By this technique, a virtually unlimited variety of graphics can be applied to closures, without adversely affecting the sealing and tamper-evidence capabilities of the closures. These techniques ordinarily entail application of ink to a film carrier, such as formed from water-soluble polyvinyl alcohol (PVA). This type of film material (such as frequently used for detergent pouches, breath-freshness strips, and the like) dissolves upon contact with water, usually in about 60 seconds or less, thus leaving the decorative ink printed on the film for application to articles to be coated.

Heretofore, the typical process for applying hydro-graphics to closures and other articles has entailed printing the hydro-graphic film with ink, and thereafter drying the ink. For application, the ink side of the dried film is rewetted with a solvent (sometimes referred to as reactivated), and the film floated on the surface of a dip tank which holds the water bath into which articles are introduced for coating. After the film dissolves, the articles are moved downwardly through the ink carried on the surface of the water bath so that water pressure acts to apply the hydro-graphic ink to the surface of the article. Because the typical inks are hydro-phobic in nature, wetting of the articles is avoided prior to their introduction downwardly into the water bath through the ink layer.

Heretofore, hydro-graphic films have typically been produced by gravure printing, which is advantageous in that printing can be effected at relatively high speed, with the films thereafter dried and rolled for subsequent application to articles. However, customization is somewhat limited, in that a new gravure roll must be fabricated for any desired changes in the pattern being produced. Additionally, the water soluble film is typically printed on a 4 to 9 color gravure printing press, which requires film unwinding, printing, drying, and winding for each color. The gravure rolls transfer ink via surface energy and contact with the film, and complete drying of each added color is essential for this process.

Non-contact, ink-jet printing techniques have also been employed for producing hydro-graphic films, with the digital nature of the printing process facilitating customization. However, it will appreciated that the required step of drying the printed film, prior to introduction into the water bath, decreases the efficiency of the coating process. Linear process speeds for coating are typically significantly higher than the linear speeds at which film can be digitally printed and dried. Digital printers typically run no faster than 1.1 linear feet/minute, while water transfer printing processes typically operate at speeds no slower than 4.0 linear feet/minute, thus resulting in a processing discrepancy of 2.9 linear feet/minute, undesirably creating a “bottleneck” in article coating, and precluding “in-line” processing and coating of articles. Additionally, the required reactivation of the ink of the film can sometimes be problematic, since aside from the cost of the activator solvent, there can instances of use of either insufficient or excessive activator solvent, and well as instances of uneven distribution of the solvent.

The present invention seeks to overcome the drawbacks associated with the conventional coating of articles with hydro-graphic film ink by effecting coating without drying of the film ink, thus maintaining the ink in an activated state, and avoiding processing inefficiencies and problems and costs associated with ink reactivation.

### SUMMARY OF THE INVENTION

In accordance with the present invention, a method of coating a plastic closure contemplates application of a patterned, hydro-graphic film to each individual molded plastic closure. These types of hydro-graphic films can be provided in a virtually unlimited variety of patterns and configurations, including wood grain, woven fabric, animal print, and like patterns. Fanciful or abstract patterns may also be applied. Patterns in the form of photo-realistic images of products within the associated container and closure package can be employed to enhance the visual appeal of such packaged products. Graphic patterns may include commercial or sports logos, or the like, lending to the appeal of such closures, and even imparting a collectable quality to the molded closure products.

The present invention is directed to a method of coating articles, such a plastic closures, with hydro-graphics, which method greatly facilitates efficient and cost-effective processing. Notably, the present method contemplates that the hydro-graphic film to be applied to one or more articles is introduced into a water bath without first drying the ink from which the film is formed, thereby utilizing the wetness of the freshly printed film ink as a means of ink transfer. Not only does this result in significant time savings and enhanced processing versatility, the cost of the typical activation solvent is avoided, as are problems associated with improper solvent application.

In accordance with one aspect of the present invention, a method of coating a plastic closure comprises the step of providing a plastic closure having a circular top wall portion, and an annular skirt portion depending from the top wall portion. The annular skirt portion may be provided with an internal thread formation for cooperative, threaded engagement with an external thread formation of an associated container, which together provide a suitable package for the container's contents. The present method further contemplates providing a patterned hydro-graphic film, and applying the patterned hydro-graphic film to an exterior surface of the closure to thereby form a coated plastic closure. The exterior surface of the closure includes the outwardly facing surfaces of the top wall portion and the annular skirt portion.

In order to enhance the aesthetic and tactile appeal of the coated plastic closure, the coated plastic closure can be textured. It is contemplated that such texturing can be effected by texturing the exterior surface of the closure prior to the step of applying the patterned hydro-graphic film thereto. Alternatively, or additionally, the patterned hydro-graphic film can be textured to provide the desired textured, coated plastic closure.

In accordance with a further aspect of the present invention, a method of coating articles comprises the steps of providing one or more of articles to be coated, wherein each of the articles has at least one surface to be decorated. The present method further includes printing a film with ink, and transferring the printed film to the surface of a fluid container, typically a water dip tank. Notably, the film is preferably transferred without drying of the ink from which the film is printed.

The present method further contemplates immersing the one or more articles in the fluid container, so that the hydro-graphic film ink is applied to the surface of each of the articles to be decorated. Thus, the present invention contemplates that the drying step of the typical coating process is avoided, since the ink is maintained in an activated state for a sufficient length of time as to effect transfer to the articles, thus eliminating the activation step within the process. After immersion, the one or more coated articles are dried and/or cured as required to attain the desired durability of the coating.

In another aspect of the invention, the printing step and the transferring step are controlled and coordinated, thus desirably promoting processing efficiency. In accordance with the present method, ink is maintained in fluid state, so that the ink is applied to the articles without additional activation of the ink.

Other features and advantages of the present invention will become readily apparent from the following detailed description, the accompanying drawings, and the appended claims.

### BRIEF DESCRIPTION OF THE DRAWINGS

FIG. 1 is a partial side elevational view of containers having closures fitted thereto, which closures have hydro-graphics applied thereto in accordance with the present invention;

FIG. 2 is a perspective view of a closure having hydro-graphics applied thereto in accordance with the present invention;

FIG. 3 is a perspective view of another closure having hydro-graphics applied thereto in accordance with the present invention;

FIG. 4 is a perspective view of another closure having hydro-graphics applied thereto in accordance with the present invention;

FIG. 5 is a perspective view of another closure having hydro-graphics applied thereto in accordance with the present invention;

FIG. 6 is a flow diagram illustrating the steps of a method of providing hydro-graphic on a water bath; and

FIG. 7 is a flow diagram illustrating the steps of another method of providing hydro-graphic film on a water bath.

### DETAILED DESCRIPTION OF THE PREFERRED EMBODIMENTS

While the present invention is susceptible of embodiment in various forms, there is shown in the drawings and will hereinafter be described presently preferred embodiments, with the understanding that the present disclosure is to be considered an exemplification of the invention, and is not intended to limit the invention to the specific embodiments illustrated or described.

The appended FIGS. 1-5 illustrate various embodiments of a coated plastic articles in the form of closures 10 embodying the principles of the present invention. As illustrated in the various embodiments, each coated plastic closure 10 includes a circular top wall portion 12 and an annular skirt portion 14 depending from the top wall portion 12. By virtue of the generally cylindrical configuration of the closure 10, each closure defines a vertical axis which extends through the center of the top wall portion 12.

In accordance with the present invention, a patterned hydro-graphic film 20 is applied to the exterior surface of the closure 10, including the outwardly facing surfaces of top wall portion 12, and annular skirt portion 14. A pattern of the hydro-graphic film 20 is registered with a physical feature of the closure, such as the vertical axis of the closure, at least one of an upper and lower margins 14a, 14b of the annular skirt portion 14, or a circumference which extends about the cylindrical closure.

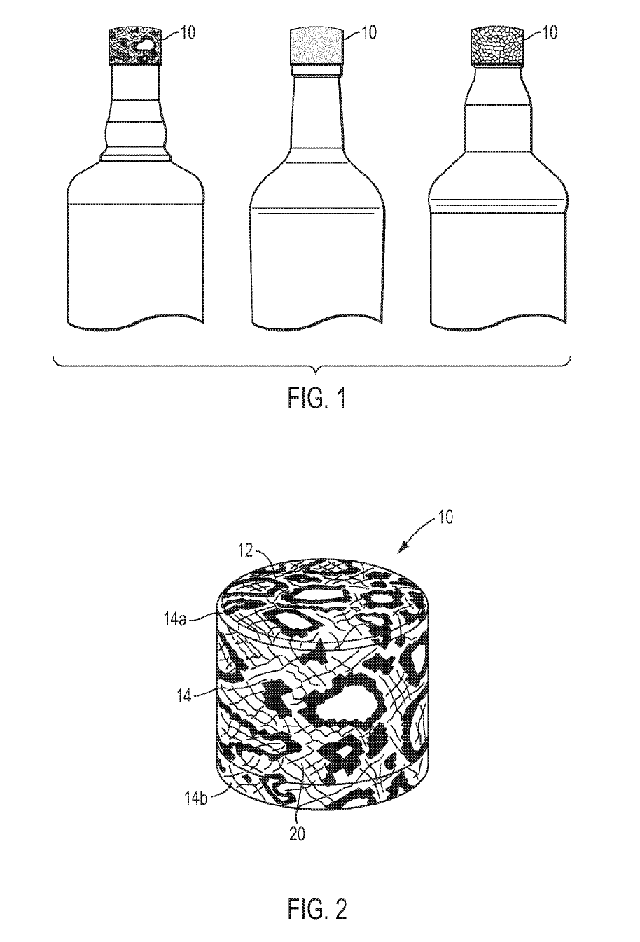

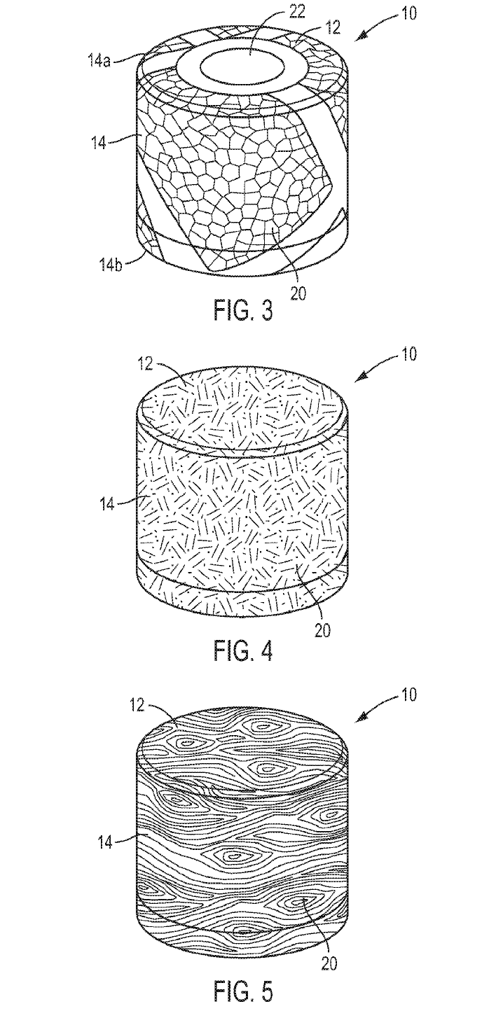

The drawings illustrate various types of patterned hydro-graphic films which can be applied to the coated plastic closure 10. Such patterns may include a wood grain pattern (FIG. 5), a woven fabric pattern (FIG. 4), an animal print pattern (FIG. 2), or other fanciful or natural patterns. In the illustrated embodiment of FIG. 3, the pattern includes a discrete graphical element 22, such as a commercial or sports logo, which can be registered with the closure 10, such as by substantial alignment with a physical feature of the closure, such as the vertical axis, whereby the graphical element 22 is centered on the top wall portion 12 of the closure. In this specific embodiment, it is contemplated that a sports-themed graphical element 22 can be provided in association with an appropriate pattern, such as a leather-like pattern resembling a basketball for use in association with a basketball team logo. It is contemplated that hydro-graphic films can be formed to include photo-realistic patterns of food products representative of, or related to, the contents of the associated closure and container package. As will be appreciated, such photo-realistic patterns very desirably enhance the aesthetic appeal of such packaging.

Techniques are known by which a hydro-graphic film is applied to an associated molded plastic closure. Generally speaking, the patterned hydro-graphic film is suspended or floated in a water bath, and individual ones of the plastic closures are generally immersed through the hydro-graphic film into the water bath, whereby the hydro-graphic film is applied to the exterior surfaces of the closure. Emersion of each closure in a pre-determined relationship with the associated hydro-graphic film can effect registration of the pattern of the hydro-graphic film with a physical feature of the closure.

A typical method of applying a hydro-graphic film to an articles includes the following steps;
1) Printed PVA (polyvinyl alcohol) is placed PVA side down into a warm bath of water;
2) Warm water dissolves the PVA layer leaving the hydrophobic ink layer behind;
3) An “activator” is sprayed onto the ink layer to soften its surface and promote bonding to the part surface;
4) Most polyolefin parts are spray coated with a series of bond promoters prior to immersion;
5) The ink readily conforms to the part's surface as the part is gently pushed through the water;
6) The activator acts as a coalescing agent between the part and the ink forming a strong bond;
7) After the part is removed, it is spray washed with water, heat dried, then clear coated.

The steps for applying a hydro-graphic film to an article formed from a polyolefin, such a high density polyethylene (HDPE) or polypropylene (PP), include application of an ether coat and a base coat prior to application of the hydro-graphic film to the article. Applying a hydro-graphic film to an article formed from an amorphous material, such as acrylonitrile butadiene styrene (ABS), typically does not contemplate the steps of applying an ether coat and a base coat.

It is contemplated that the present method can be practiced for applying coatings to a wide variety of articles. While the present method has found particular application for applying coatings to closures molded from a polymeric material, the present invention is applicable for coating a wide variety of articles, formed from metallic as well as polymeric materials, with hydro-graphic film ink. For coating closures, application of the hydro-graphic film ink to an exterior surface of each closure is contemplated, but it is envisioned that for some applications, an article can be formed from transparent polymeric material and a coating applied to an interior surface, thus providing the desired decorative effect with enhanced durability and resistance to abrasion or other damage.

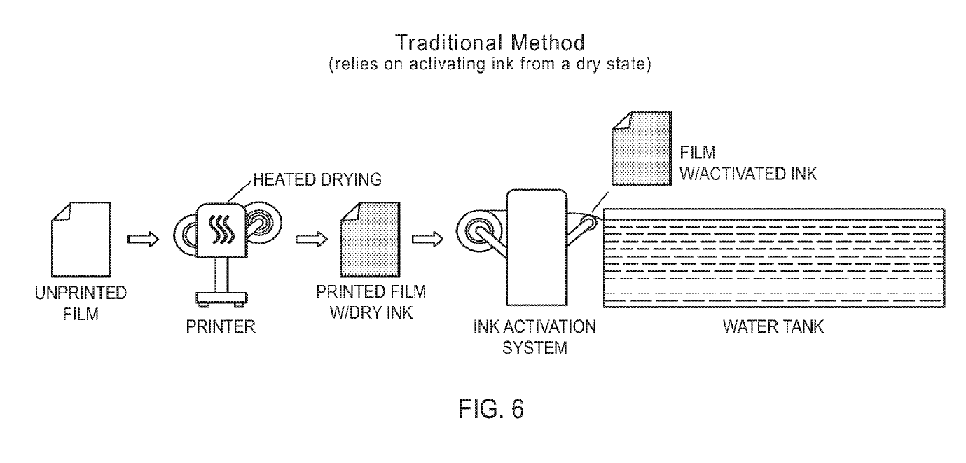

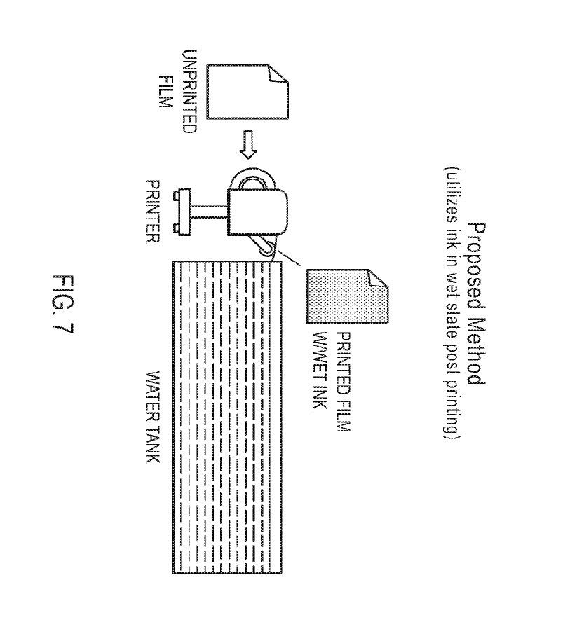

FIG. 6 is a flow diagram illustrating a method of providing a hydro-graphic film on a water bath, generally in accordance with known techniques, which can be employed for practicing the present invention, including providing one or more of articles to be coated, wherein each of the articles has at least one surface to be decorated.

In accordance with a further aspect of the present invention, illustrated in FIG. 7, the present method further includes printing a film with ink, and transferring the printed film to the surface of a fluid container, typically a water dip tank. Notably, the film is preferably transferred without drying of the ink from which the film is printed.

The present method further contemplates immersing the one or more articles in the fluid container, so that the hydro-graphic film ink is applied to the surface of each of the articles to be decorated. Thus, this aspect of the present invention contemplates that the ink-drying step of the typical coating process is avoided, since the ink is maintained in an activated state for a sufficient length of time as to effect transfer to the articles, thus eliminating the activation step within the process. After immersion, the one or more coated articles are dried and/or cured as required to attain the desired durability of the coating.

In another aspect of the invention, the printing step and the transferring step are controlled and coordinated, thus desirably promoting processing efficiency. In accordance with the present method, ink is maintained in fluid state, so that the ink is applied to the articles without additional activation of the ink.

Thus, this aspect of the present invention desirably addresses the digital printing speed limitations associated with previous techniques associated with the required drying process, increasing processing speeds from 1.1 linear feet/minute up to as much as 11.1 linear feet/minute, or more, because the wet ink is maintained in a desirable state for processing. The present method also desirably eliminates the need for the typical ink activation step of the traditional process. Additionally, considering the importance of sound environmental health and safety (EHS) practices, elimination of the activation step eases meeting requirements for providing explosion proofing, while reducing respiratory concerns.

This aspect of the present invention also desirably eliminates the additional cost from rewetting the ink via the application of the activator solvent. Notably, the printing ink is maintained in its virgin state of wetness, an ideal condition for transfer for application to and coating of articles. Those familiar with the art are aware that one of the most problematic aspects of water transfer printing relates to the ink activation process, and thus by eliminating difficulties associated with ink activation (e.g., too much activator, not enough activator, uneven activator distribution), it is believed that more consistent ink transfers can be achieved.

Notably, a variation of this aspect of the present invention contemplates the application of decorative ink to a carrier film as the film is carried on the surface of fluid in a fluid container, such as on the surface of a water bath in a dip tank. For this aspect of the invention, the carrier film is transferred to the surface of a fluid, such as water, and the ink is then printed onto the film as it is carried on the surface of the fluid. Articles to be coated are then immersed downwardly into the fluid container without drying of the ink. The ink is thus applied to the desired surface of each of the articles to be coated. Greatly enhanced processing efficiency can be achieved, with the digital nature of the ink-jet printing process permitting cost-effective customization of the decorative coatings.

While use of solvent-based decorative inks is presently contemplated, it is within the purview of the invention that alternative ink compositions can advantageously be employed, such as ultra-violet light cured ink.

As noted above, control and coordination of the printing and coating processes is contemplated for maximizing the efficiency of the overall processing. In this regard, for some applications it may be desirable to stretch or elongate the printed film while in the fluid container, prior to introduction of articles to be coated. This can help to maximize efficient use of the hydro-graphic film.

### EXAMPLE

Stage 1: ink to film transfer (film printing)
Equipment
Printer: digital inkjet printer
   Print Method: Valve Jetting, Drop-On Demand, Piezo Drive Method
   # of nozzles: (180×8 rows)×1 head
   Minimum droplet size: 3.5 pl
   Number of print heads: 1 (CMYK)
   Head Height: 1.5 mm/2.5 mm
   Max print speed/resolution 600 sqf/h/360×360
   Max resolution: 1440 dpi
   Max media width: 64″
Consumables
Ink: pigment based with solvent carrier (45-55% ethyl lactate and 35-45% ethylene glycol monobutyl ether acetate mix)
Media: PVA water soluble film (1 m wide at 35 μm thickness)
Output
Printed film: graphically printed PVA film with ink still in wetted state
Key printer settings
Print temperature: ambient 68-72° F. (disable all conventional heat curing processes)
Print resolution: 720×720 DPI
Color mode: CMYK variable dot
Print dither: SO diffusion
Print speed: 151 sq. ft. per hour
Procedure
1. Insure ink and film are properly loaded into printer
2. Load digital image into applicable printer parameter adjustment software
3. Confirm key print settings match those listed above
4. Proceed to stage 2
Stage 2: ink to part transfer (part dipping)
Equipment
Dip tank: open top water holding vessel (temperature controllable 60″ wide×120″ long×36″ tall stainless steel tank with filtering weir)
Consumables
Printed film: graphically printed PVA film with ink still in wetted state
Film dissolving agent: water (softened tap held at a temperature between 80-90° F.)
Parts: molded polyolefin closures
Output
Decorated parts: 3 dimensionally outer surface printed closures
Procedure
1. Post digital ink jet print immediately cut film from printer and transfer wet ink side up to dip tank
2. Immerse the part into the film's surface within 60 s of entering the tank
3. Remove part from tank
4. Rinse residual PVA from part
5. Dry part
6. Part is now fully decorated
   From the foregoing, it will be observed that numerous modifications and variations can be effected without departing from the true spirit and scope of the novel concepts of the present invention. It is to be understood that no limitation with respect to the specific embodiments is intended or should be inferred. The disclosure is intended to cover, by the appended claims, all such modifications as fall within the scope of the claims.

1. A method of coating articles, comprising the steps of:
providing one or more articles to be coated, wherein each said article has at least one surface to be decorated;
printing a film with ink;
transferring the printed film to the surface of a fluid container, wherein said film is transferred without drying of the ink from which the film is printed; and
immersing said plurality of articles in said fluid container, and removing said article from said fluid container so that said ink is applied to said surface of each of said articles.

2. A method of coating articles in accordance with claim 1, wherein
said printing step and said transferring step are controlled and coordinated.

3. A method of coating articles in accordance with claim 1, wherein
said ink is maintained in a fluid state, so that said ink is applied to said articles without additional activation of said ink.

4. A method of coating articles in accordance with claim 1, wherein
said one or more articles include closures molded from a polymeric material each having a surface to which said ink is applied.

5. A method of coating article in accordance with claim 1, wherein
each of said one or articles are dried and/or cured after immersion.

6. A method of coating article in accordance with claim 1, wherein
each of said articles comprises a closure molded from a polymeric material having a circular top wall portion, and an annular skirt portion depending from said top wall portion, wherein said surface to which said ink is applied is an exterior surface of said top wall portion and said skirt portion.

7. A method of coating articles, comprising the steps of:
providing one or more of articles to be coated, wherein each said article has at least one surface to be decorated;
transferring a film to the surface of a fluid in a fluid container;
printing an ink onto the film;
immersing said one or more article in said fluid container without drying of the ink printed onto the film, and removing said one or more articles from said fluid container so that said ink is applied to a surface of each of said one or more article.

8. A method of coating articles in accordance with claim 7, wherein
each of said articles comprises a closure molded from a polymeric material having a circular top wall portion, and an annular skirt portion depending from said top wall portion, wherein said surface to which said ink is applied is an exterior surface of said top wall portion and said skirt portion.
